(19) United States
(12) Patent Application Publication
(10) Pub. No.: US 2003/0122636 A1
(43) Pub. Date: Jul. 3, 2003

(54) Radio frequency coaxial cable and method for making same

(76) Inventor: Arturo DiBenedetto, Mokena, IL (US)

Correspondence Address: Welsh & Katz, Ltd., Eric D. Cohen, 22nd Floor, 120 South Riverside Plaza, Chicago, IL, 60606, US

(21) Appl. No.: 10/034,226

(22) Filed: Dec. 28, 2001

(51) Int. Cl. H01P 3/00

(52) U.S. Cl. 333/237

(57) ABSTRACT

An RF radiating cable includes a tubular inner conductor, a layer of foam dielectric material surrounding the inner conductor, and a burst-resistant internal layer of flame retardant material longitudinally wrapped about the foam material. A metallic outer conductor is longitudinally wrapped about flame retardant material, where the outer conductor having a plurality of apertures formed therein. A jacket of weather-proofing material is formed as an extruded layer surrounding the outer conductor.

### FIELD OF THE INVENTION

The present invention relates generally to a radio frequency (RF) cable, and more specifically to an RF radiating cable having a burst-resistant internal flame retardant layer and method for making same.

### BACKGROUND

The use of coaxial cables of either the foam type or the air dielectric type is widespread for antenna feeding arrangements in communication systems. Typical applications include antenna systems for terrestrial microwave systems, cellular and land mobile radio, broadcast transmitting antenna systems, earth-station antenna systems, and high-frequency communication systems. Such coaxial cables function essentially to transmit electrical signals from a generating station to some form of antenna from where the signals are radiated.

Coaxial cables of the radiating kind, on the other hand, are designed to themselves function as continuous antennas so that RF signals are transmitted directly from the cables, rather than from an antenna. Such radiating or “leaky” coaxial cables serve as efficient and economical sources for transmitting RF signals where the use of conventional antennas is impractical. Radiating cable systems are particularly important in two-way mobile radio, radio paging and other localized broadcasting services in applications involving extended underground installations such as railways, mines and tunnels where conventional centralized VHF and UHF communication systems are not practical.

Regardless of the particular application, a common requirement of coaxial cables is high retardancy to flame propagation. Over-heating of cables when subjected to current overloads or related system failures can initiate fires. More importantly, when electrical equipment has already been subjected to fire, the cables used therein may themselves contribute to flame propagation and may also produce noxious fumes and smoke.

Foam dielectric coaxial cables are particularly suited to antenna feeder systems that do not require a pressure path to the antenna, and are hence often specified in applications using land mobile radio, cellular radio, or terrestrial microwaves links. In such applications it is important that the cables do not contribute to flame propagation in case of fire.

For quite some time coaxial cables have been afforded flame retardant properties by sheathing the cables with halogen-containing materials, such as polyvinyl chloride (PVC) or other flouroplastic materials. However, upon exposure to fire, the halogen containing materials in the sheaths generate noxious smoke and form toxic and corrosive gases. Beside being a substantial safety hazard, the use of such cables leads to secondary damages resulting from degradation of the fire-retardant material.

Flame retardant cables based on halogen-free materials, such as olefin-copolymers and other high-oxygen index materials, have subsequently been developed. Improved flame retardant and fire resistant properties are provided by such cables by the process of cross-linking the halogen-free materials. Such cables, however, are very expensive and are generally stiff and unpliable.

One problem particular to radiating cables of the foam-dielectric type arises due to the very construction of such cables. In a radiating cable, slots or other apertures are provided in the outer conductor to allow a controlled portion of the transmitted RF signal to radiate, thus creating elemental radiating sources along the entire length of the cable. The outer conductor itself surrounds an assembly consisting of a foam core extruded onto an inner conductor. The entire coaxial assembly is then jacketed with a flame retardant material. With this type of construction, when the cable is subjected to high heat conditions in a fire, the foam inside the cable melts and “bubbles out” of the apertures in the outer conductor, and can penetrate the softened external jacket so as to be exposed to the fire. Consequently, flames propagate rapidly along the cable and can lead to total destruction of the cable. As a result, most existing radiating cables are incapable of passing stringent flame tests, such as the IEEE 383 test.

Improved flame retardancy in radiating cables has been conventionally achieved by resorting to the costly cross-linking technique. In addition to using a cross-linked jacket material, the polymer material used as the dielectric itself has been cross-linked so that the foam will only char and will not bum or melt when subjected to high heat. This approach not only makes the radiating cables very expensive, but the use of cross-linked material makes the cables rigid and nonpliable so that installation and working of the cables is difficult and expensive. The cross linking process also results in the deterioration of dielectric properties of cable insulation and jacket materials. In the case of radiating cables, where signals propagate along the surface of the outer conductor close to the jacket, the application of an electrically lossy jacket material over the cable results in poor signal transmission characteristics.

In some RF cables, the layer of flame proofing material is wound over the outer conductor after apertures have been milled into the outer conductor to permit the cable to radiate RF signals. This is disclosed in U.S. Pat. No. 4,800,351 to Rampalli et al. and also owned by the assignee of the present invention. In known cables, the flame proofing material or tape is helically wound so that the degree of overlap can be established, where the degree of overlap provides an effectiveness “thickness” of the tape so as to meet the specific flame tests. With respect to manufacturing processes, helical or spiral wrapping of the flame proof tape is very inefficient because spools or rolls of tape must rotate around the cable as the cable linearly progresses along the manufacturing line. Because the material is wrapped about the circumference of the cable, much more tape is used relative to the length of the cable section wrapped. Accordingly, either the production line must be stopped to restock the rolls of tape, or the cable is cut into shorter sections for final reeling, which is costly.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a side elevational view of a specific embodiment of an RF cable according to the present invention;

FIG. 2 is a front cross sectional view of the cable of FIG. 1; and

FIG. 3 is a pictorial view of a specific embodiment of a device for manufacturing the cable of FIG. 1.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

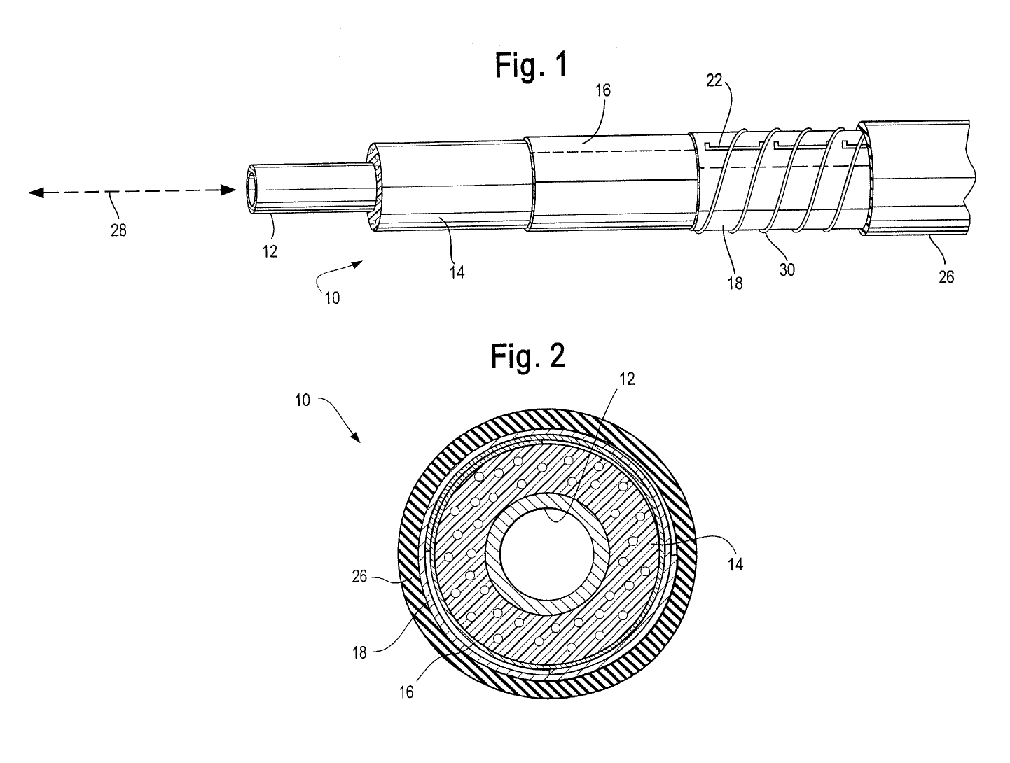

Referring now to FIGS. 1 and 2, a radiating cable is shown generally as 10. The radiating cable 10 includes an inner conductor 12 at the center of the cable, which is surrounded by a foam layer or body 14. A layer or strip of flame retardant material 16 may then be longitudinally wrapped about the foam layer 14. An outer conductor 18, having a plurality of radiating apertures 22, may then surround the layer of flame retardant material 16. A weather-proof jacket 26 is then provided over the outer conductor 18.

The inner conductor 12 may be generally made of a smooth or corrugated conducting material, such as copper, aluminum or copper-clad aluminum. The inner conductor 12 may be corrugated to increase the flexibility of the cable 10. Preferably, the inner conductor 12 is tubular, but may also be solid or stranded depending upon the application and the frequency range of the cable 10.

In one specific embodiment, the inner conductor 12 is surrounded by the layer of low-loss foam dielectric material 14, such as cellular polyethylene or the like. The foam material 14 is preferably extruded about the inner conductor 12 through a cross-head, which applies the foam about the entire circumference of the inner conductor. The foam layer 14 provides structural support for the cable 10 and evenly spaces the outer conductor 18 from the inner conductor 12 in a coaxial arrangement. Accordingly, a fixed distance is maintained between the inner conductor 12 and the outer conductor 18 along the entire length of the cable 10.

In the present radiating cable 10, the flame retardant layer 16 is disposed directly over the foam layer 14 and under the outer conductor 18. Additionally, the flame retardant layer 16 is “cigarette-wrapped” or longitudinally wrapped along a longitudinal axis 28 of the cable 10. This provides increased “burst” strength and facilitates retaining the foam layer 14 within the flame retardant layer 16 should the cable 10 be subjected to a high heat environment. The burst-resistant internal flame retardant layer 16 thus formed, substantially prevents the foam material 14 from “bubbling out” through the apertures 22 in the outer conductor 18 when the cable 10 is heated and the foam has melted. The longitudinal edges of the flame retardant layer 16 may overlap by about between five percent to fifty percent of its circumference. Additionally, a suitable chemical adhesive may be used to “spot-glue” the flame retardant layer 16 in place to prevent unwrapping prior to final jacketing. Alternatively, a bead of suitable chemical adhesive may be used to prevent unwrapping of the flame retardant layer.

The burst-resistant internal flame retardant layer 16 is selected from a material capable of serving as an insulating barrier even when exposed to flames or heat up to at least 1200° C. In addition, the composition of the flame retardant layer 16 is preferably chemically inert, non-toxic and contains no halogenated substances. The composition is also preferably impervious to water, and is radiation resistant, acid-resistant and alkaline-resistant. It is also preferred that the flame retardant layer 16 have good tensile strength, in addition to being dry, non-tacky, and flexible. A preferred composition for the flame retardant tape includes an inorganic refractory material, such as electric grade mica, which is impregnated with a heat resistant binder and combined with a suitable carrier material, such as fiberglass. The refractory material preferably displays a suitably low dissipation factor when used in the cable 10 at the frequencies at which radiating coaxial cables commonly operate. This ensures that the presence of the flame retardant layer 16 does not significantly affect the electrical characteristics of the cable 10. One example of a suitable material from which to form the flame retardant layer 16 is polyimide film, which is commercially available from Dupont Co. under the name KAPTON.

The outer conductor 18 may be preferably made from thin metal, such as copper foil, but any suitable metal, such as aluminum or copper clad aluminum may also be used. The foil is preferably about three mils in thickness, but any suitable gauge metal may be used depending upon the application and the size of the cable 10. In one specific embodiment, the outer conductor 18 is preferably a continuous metal foil layer and is initially formed from a strip of metal foil, which may be fed from roll or spool of material during the manufacturing process, as described below. The outer conductor 18 is preferably longitudinally wrapped about the cable 10 during manufacture. The longitudinal edges of the outer conductor 18 may overlap by about between five percent to fifty percent of its circumference. Alternately, the outer conductor 18 may have minimal overlap and the seam may be welded or spot welded. Any suitable process may be used to secure the outer conductor in place.

Note as described above, both the burst-resistant internal flame retardant layer 16 and the outer conductor 18 are preferably in the form of a continuous strip of material in reel or spool form prior to formation over the foam layer 14. As the flame retardant layer 16, and subsequently the outer conductor 18, are longitudinally wrapped, a thin string 30 may be helically wrapped about the outer conductor to prevent it from unwrapping prior to application of the weather-proof jacket 26. Preferably, the string is formed of KEVLAR because of its high strength properties. As such, the KEVLAR string 30 will not become inadvertently severed if it contacts the sharp edges of the outer conductor 18. Additionally KEVLAR material is electrically neutral and will not interfere with the RF properties of the cable.

The outer conductor 18 may be provided with the plurality of pre-formed slots or radiating apertures 22 arranged along the axial length of the outer conductor. Preferably, the slots 22 are evenly spaced linearly along the length of the cable 10. The terms “radiating aperture” and “slot” are used interchangeably herein. The slots 22 are preferably U-shaped as shown in FIG. 1, but may also be any other shape, such as oval, circular, polygonal, and the like. The radiating apertures 22 in the outer conductor 18 permit a controlled portion of the radio frequency signals being propagated through the cable 10 to radiate from elemental sources along the entire length of the cable 10 so that the coaxial cable in effect functions as a continuous antenna. Although the radiating apertures 22 are preferably U-shaped, any suitable shape and linear spacing between the apertures may be used depending upon the application an the frequency range of a signal carried by the cable 10. In operation, when installing the cable 10, for example, in tunnel, the slots are preferably aligned to face toward the hollow portion of the tunnel and away from the tunnel wall to which it is affixed. This permits the RF signals to more effectively radiate into the space defined by the tunnel.

Preferably, the slots 22 are arranged along a longitudinal axis of the outer conductor 18 so that when the outer conductor is wrapped about burst-resistant internal flame retardant layer 16, the slots are not longitudinally aligned with the seam of the burst-resistant internal flame retardant layer.

The outer conductor 18 is preferably smooth, but may also be corrugated to provide additional cable flexibility. It may be helically or spirally corrugated or it may be ribbed. If the outer conductor is corrugated, the corrugation process is applied after the outer conductor 18 is longitudinally wrapped about the cable. Also, the slots 22 are pre-formed in the outer conductor 18 whether or not the outer conductor is corrugated.

Note that in some known radiating cables the flame proof material is helically wrapped over the outer conductor, as described above. When such cables are subjected to extreme heat conditions, the external jacket material, despite being flame retardant, softens at higher temperatures. In addition, the foam dielectric material melts at higher temperatures, and as the temperature continues to rise, there is a risk that the melted foam may “bubble” through the apertures in the outer conductor and create pressure against the flame proof layer. The bubbling dielectric material may be forced against the softened outer jacket and eventually may penetrate both the flame proof layer and the outer jacket and may be exposed directly to the fire. The melted dielectric material would than feed the fire and freely propagate flames, possibly leading to complete destruction of the cable.

In the present radiating cable 10, even if the material of the weather-proof jacket 26 softens appreciably under high heat conditions, the melted (“bubbling”) foam cannot penetrating the jacket because it is not able to exit the radiating apertures 22 due to the longitudinally wrapped burst-resistant internal flame retardant layer 16. The added force against the flame retardant layer 16 by the outer conductor 18, which surrounds it, effectively increases the “bursting” strength of the flame retardant layer so as to further retain the foam layer should it melt. Essentially, it is more difficult for the melted foam to burst through the flame retardant layer under the slots while the outer conductor 18 acts to physically contain to foam.

Preferably, the weather-proof jacket 26 is made of a flame retardant non-halogenated thermo-plastic material. Consequently, the weather-proof jacket 26 material can be of a less fire-retardant grade. Also, there is no need for the jacket material or the dielectric core itself to be cross-linked. The weather-proof jacket 26 is formed of a self-extinguishing and low dielectric loss material, as such properties are advantageous in radiating cables. The material from which the weather-proof jacket may be formed is commercially available from Scapa Polymerics, Ltd. under the trade name MEGOLON. Alternatively, the material used may be commercially available form the General Electric Company under the trade name NORYL-PX 1766.

From the foregoing, it is apparent that the present invention provides a radiating cable of the foam dielectric type with significantly improved flame retardancy without the accompanying loss of economy or degradation in electrical characteristics that results from the conventional use of cross-linked polymer material for the dielectric layer and/or the protective external jacket. Radiating cables formed in accordance with this invention do not propagate flames, are easily manufactured, and may conveniently installed by virtue of their superior flexibility.

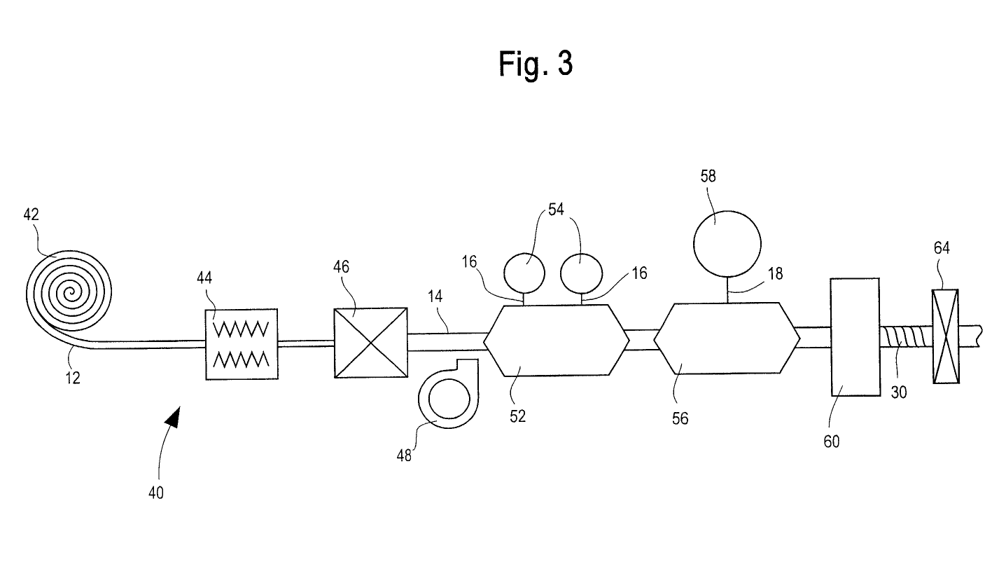

Referring now to FIGS. 1 and 3, FIG. 3 shows a pictorial view of a manufacturing line 40 for producing the present radiating cable 10. In an initial step, the appropriately sized inner conductor 12 is fed into the manufacturing line 40 from a spool 42. The inner conductor 12 may be optionally corrugated, either annularly or helically, by a corrugating device 44 to provide additionally cable flexibility. Next, the foam dielectric material 14 may be extruded via a cross-head 46 onto the inner conductor 12 to form the foam body 14. The foam material 14 is then allowed to cool and solidify, or may be actively cooled by an air bath device 48 or water-based cooler, as is known in the art.

Next, the inner conductor 12 with the hardened foam body 14 is fed to a first forming tray 52. One or two rolls 54 of the flame retardant material 16 is fed from the rolls into the forming tray 52 for application over the foam layer 14. The burst-resistant internal flame retardant layer 16 is “cigarette-wrapped” along the longitudinal axis 28 of the cable 10, and the cable is then routed to a second forming tray 56. The second forming tray 56 includes a reel or spool 58 containing the outer conductor 18 having the pre-formed slots 22. The second forming tray 56 then longitudinally wraps the outer conductor 18 about the foam body 14 and the flame retardant layer 16. Next, the optional KEVLAR string 30 may be wrapped about the outer conductor 22 to prevent inadvertent unwrapping. A helical string wrapping device 60 may apply the KEVLAR string. Optionally, the outer conductor 18 may be spot welded or seam welded to form a closed tube outer conductor. Next, the entire cable assembly 10 is fed through a jacket extruder 64 or crosshead to apply a layer of liquid weather-proof jacketing 26. The jacketing 26 then cooled via a water bath. The finished cable 10 is then wrapped about a reel of appropriate size.

Specific embodiments of an RF coaxial cable according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. An RF radiating cable comprising:
an inner conductor;
a layer of foam dielectric material surrounding the inner conductor;
a burst-resistant flame retardant layer longitudinally wrapped about the foam material;
a metallic outer conductor wrapped about flame retardant material, the outer conductor having a plurality of apertures formed therein; and
a jacket of weather-proofing material surrounding the outer conductor.

2. The cable according to claim 1 wherein the inner conductor is corrugated to provide flexibility.

3. The cable according to claim 1 wherein the inner conductor is a smooth-walled hollow structure.

4. The cable according to claim 1 wherein the foam material is extruded about the inner conductor.

5. The cable according to claim 1 wherein the foam material provides structural support and evenly spaces the outer conductor from the inner conductor in a coaxial arrangement.

6. The cable according to claim 1 wherein the burst-resistant flame retardant layer is longitudinally wrapped and has an overlap of about between five percent to fifty percent of its circumference.

7. The cable according to claim 1 wherein the burst-resistant flame retardant material includes an adhesive material to prevent unwrapping.

8. The cable according to claim 1 wherein the burst-resistant flame retardant layer substantially prevents the foam material from bubbling out through the apertures when heated.

9. The cable according to claim 1 wherein the burst-resistant flame retardant layer substantially prevents the foam material from bursting through the apertures in the outer conductor.

10. The cable according to claim 1 wherein the apertures are RF radiating apertures configured to emit RF signals.

11. The cable according to claim 1 wherein the apertures have a predetermined shape and spacing therebetween depending upon a frequency range of a signal carried by the cable.

12. The cable according to claim 1 wherein the apertures are pre-formed in the outer conductor before the outer conductor is applied to the foam layer.

13. The cable according to claim 1 wherein the apertures are in the form of slots evenly spaced along a length of the outer conductor.

14. The cable according to claim 1 wherein the apertures are U-shaped.

15. The cable according to claim 1 wherein the outer conductor is a metallic foil formed from a continuous strip.

16. The cable according to claim 1 wherein the outer conductor is longitudinally wrapped and has an overlap of about between five percent to fifty percent of its circumference.

17. The cable according to claim 1 wherein a string is wrapped about the outer conductor in a spiral manner after the outer conductor is formed around the flame retardant material and before the jacket is applied so as to retain the outer conductor in an overlapped configuration.

18. The cable according to claim 17 wherein the string is a KEVLAR string.

19. The cable according to claim 1 wherein the outer conductor is a continuous metal foil layer.

20. The cable according to claim 1 wherein the outer conductor is corrugated to provide flexibility.

21. The cable according to claim 1 wherein the outer conductor is a smooth-walled hollow structure.

22. An RF radiating cable comprising:
an inner conductor;
a layer of dielectric material surrounding the inner conductor;
a burst-resistant flame retardant layer of material cigarette-wrapped about the layer of dielectric material;
an outer conductor formed about flame retardant material, the outer conductor having a plurality of RF radiating apertures; and
a weather-proof jacket surrounding the outer conductor.

23. The cable according to claim 22 wherein the inner conductor is corrugated to provide flexibility.

24. The cable according to claim 22 wherein the inner conductor is a smooth-walled hollow structure.

25. The cable according to claim 22 wherein the burst-resistant flame retardant layer is longitudinally wrapped and has an overlap of about between five percent to fifty percent of its circumference.

26. The cable according to claim 22 wherein the burst-resistant flame retardant layer substantially prevents the foam material from bubbling out through the apertures when heated.

27. The cable according to claim 22 wherein the apertures are pre-formed in the outer conductor before the outer conductor is applied to the foam layer.

28. The cable according to claim 22 wherein the outer conductor is a metallic foil formed from a continuous strip.

29. The cable according to claim 22 wherein the outer conductor is corrugated to provide flexibility.

30. The cable according to claim 22 wherein the outer conductor is a smooth-walled hollow structure.

31. An antenna comprising:
an inner conductor;
a layer of insulating material formed about the inner conductor;
a burst-resistant flame retardant layer of material cigarette-wrapped about the insulating material;
an outer conductor formed about heat resistant material, the outer conductor having a plurality of RF radiating apertures; and
a water-tight protective jacket surrounding the outer conductor.

32. The antenna according to claim 31 wherein the inner conductor is corrugated to provide flexibility.

33. The antenna according to claim 31 wherein the inner conductor is a smooth-walled hollow structure.

34. The antenna according to claim 31 wherein the burst-resistant flame retardant layer is longitudinally wrapped and has an overlap of about between five percent to fifty percent of its circumference.

35. The antenna according to claim 31 wherein the burst-resistant flame retardant layer substantially prevents the foam material from bubbling out through the apertures when heated.

36. The antenna according to claim 31 wherein the apertures are pre-formed in the outer conductor before the outer conductor is applied to the foam layer.

37. The antenna according to claim 31 wherein the outer conductor is a metallic foil formed from a continuous strip.

38. The antenna according to claim 31 wherein the outer conductor is corrugated to provide flexibility.

39. The antenna according to claim 31 wherein the outer conductor is a smooth-walled hollow structure.

40. A flame resistant cable assembly comprising:
an electrically conductive inner conductor surrounded with a layer of insulating material;
a burst-resistant flame retardant barrier layer disposed in a longitudinal manner around the layer of insulating material;
a layer of metallic foil formed about the flame retardant layer;
a plurality of RF radiating slots formed at predetermined evenly spaced locations along a longitudinal axis of the metallic foil; and
a weather proof protective layer surrounding the layer of metallic foil.

41. The cable assembly according to claim 40 wherein the inner conductor is corrugated to provide flexibility.

42. The cable assembly according to claim 40 wherein the inner conductor is a smooth-walled hollow structure.

43. The cable assembly according to claim 40 wherein the burst-resistant flame retardant layer is longitudinally wrapped and has an overlap of about between five percent to fifty percent of its circumference.

44. The cable assembly according to claim 40 wherein the burst-resistant flame retardant layer substantially prevents the foam material from bubbling out through the slots when heated.

45. The cable assembly according to claim 40 wherein the slots are pre-formed in the metallic foil before the metallic foil is applied to the insulating layer.

46. The cable assembly according to claim 40 wherein the metallic foil is formed from a continuous strip of material.

47. The cable assembly according to claim 40 wherein the metallic foil is corrugated to provide flexibility.

48. The cable assembly according to claim 40 wherein the metallic foil is a smooth-walled hollow structure.

49. A method of making an RF radiating cable comprising the steps of:
providing an inner conductor;
surrounding the inner conductor with a layer of foam dielectric material;
longitudinally wrapping a layer of flame retardant material about the foam material along a longitudinal axis of the cable;
applying a metal foil outer conductor about flame retardant material along the longitudinal axis of the cable, the outer foil having a plurality of apertures formed therein; and
applying a layer of weather-proofing material formed about the outer conductor.

50. The method according to claim 49 including the step of corrugating the inner conductor to increase flexibility.

51. The cable according to claim 49 including the step of corrugating the outer conductor to increase flexibility.

52. A method of making an RF radiating cable comprising the steps of:
providing a hollow tubular inner conductor;
surrounding the inner conductor with a layer of foam dielectric material;
longitudinally wrapping a burst-resistant layer of flame retardant material about the foam material along a longitudinal axis of the cable, the flame retardant material overlapping along a longitudinal axis;
applying a metal foil outer conductor about flame retardant material along the longitudinal axis of the cable, the outer foil having a plurality of apertures formed therein; and
extruding a layer of weather-proofing material formed about the outer conductor.
